(19) United States
(12) Patent Application Publication
(10) Pub. No.: US 2012/0089521 A1
(43) Pub. Date: Apr. 12, 2012

(54) METHOD AND APPARATUS FOR BILLING PURCHASES FROM A MOBILE PHONE APPLICATION

(76) Inventors: Adam ABREVAYA, Burlington, MA (US); David Meppelink, Chelmsford, MA (US)

(21) Appl. No.: 13/004,788

(22) Filed: Jan. 11, 2011

Related U.S. Application Data
(60) Provisional application No. 61/293,992, filed on Jan. 11, 2010.

(51) Int. Cl. G06Q 30/06; H04L 9/32

(52) U.S. Cl. 705/75; 705/26.1

(57) ABSTRACT

A method and apparatus is provided for mobile communication device application user to purchase content or functionality for the application while in the midst of using it and without interrupting his user experience. In an embodiment, the user's mobile carrier subscriber account is billed directly for the purchase. The method includes receiving a request for the purchase from the communication device application, where the request includes information about the amount of the purchase. Further, the method includes sending a confirmation request to the communication device. On receiving the confirmation, authenticating the communication device at the public mobile operator network of the communication device. Finally, the method includes providing access to the purchased content or functionality on or in conjunction with the communication device.

### RELATED APPLICATIONS

This application claims the benefit of priority to U.S. Provisional Patent Appl. No. 61/293,992 titled “Method and apparatus for billing purchases from a mobile phone application” filed Jan. 11, 2010, which is incorporated by reference herein in its entirety.

### BACKGROUND OF THE INVENTION

1. Field of the Invention

The present invention relates to payment through communication devices in general. More specifically, the present invention relates to a method and apparatus for directly charging a consumer mobile service account while making a purchase through a mobile phone application.

2. Description of the Prior Art

It is well known that mobile phones are becoming increasingly sophisticated, with many supporting multiple mobile applications to be downloaded and installed. Examples of such mobile applications include, but are not limited to, mobile based games, productivity applications, and e-commerce applications. The mobile applications are divided into free mobile applications and paid mobile applications. Further, some of the mobile applications are free for a few features, but full access is provided only in a paid versions. Additionally, mobile based games can have free levels and paid levels.

A user of the mobile phone pays for the paid applications or levels from within the application or through a website. There are multiple payment options available to the user. Examples of the payment options include, but are not limited to, credit card, debit card, internet banking account. Paypal, and Google checkout. The problem arises when the user does not have an online payment accounts. Further, a few users do not feel comfortable in making purchasing online. Additionally, all of the online payment options do not provide a seamless purchase experience to the user, as the user has to go through the online payment gateway process to complete the purchase.

In the light of the foregoing discussion, there is a need for a method and system which can let users purchase through a mobile application without needing an online payment account. Further, there is a need for a method and system which can provide a seamless purchase experience to a user of a mobile phone.

### SUMMARY

Accordingly, it is an object of the present invention to provide a method and system for purchasing content through communication devices.

It is another object of the present invention to provide a method and system for making purchases by mobile phone without using credit card, internet banking or mobile banking.

It is another object of the present invention to provide a method and system for purchasing improved content or functionality for a mobile application while in the midst of using that mobile application.

The above and other objects of the present invention are achieved by providing a method and system for directly charging a consumer mobile service account while making a purchase through a communication device. The method includes receiving a request for the purchase from the communication device user, while he is in the midst of using an application for which he desires additional content or functionality. Further, the method includes authorizing the purchase request received from the communication device. On receiving the authorization, the method includes authenticating the communication device with a mobile service operator of the communication device. Further, the method includes charging the mobile service account of the consumer directly, where the charge is the amount of the purchase requested. Finally, the method includes sending information of outcome of the purchase request to the communication device.

In an embodiment of the present invention, the system for directly charging a consumer mobile service account while making a purchase through a communication device includes a reception module for receiving a purchase request from the communication device, where the purchase request includes information related to the purchase. Further, the system includes an authorization module for authorizing the purchase request received from the communication device. Further, the system includes an authentication module for authenticating the communication device with a mobile service operator of the communication device. Additionally, the system includes a billing module for charging the mobile service account of the consumer directly, where the charge is the amount of the purchase requested. Finally, the system includes an information module for sending information of outcome of the purchase request to the communication device

### BRIEF DESCRIPTION OF THE DRAWINGS

For a more complete understanding of the present invention, the needs satisfied thereby, and the objects, features, and advantages thereof, reference now is made to the following description taken in connection with the accompanying drawings.

FIG. 1 shows a flow chart of a method for directly charging a consumer wireless account for purchases, in accordance with an embodiment of the present invention.

FIG. 2 shows a flow chart of a method for directly charging a consumer wireless account for purchases, in accordance with another embodiment of the present invention.

FIG. 3 shows a flow chart of a method for directly charging a consumer wireless account for purchases, in accordance with yet another embodiment of the present invention.

FIG. 4 shows a flow chart of a method for directly charging a consumer wireless account for purchases, in accordance with yet another embodiment of the present invention.

FIG. 5 shows a flow chart of a method for paying out commissions for purchases, in accordance with an embodiment of the present invention.

FIG. 6 illustrates an environment in which various embodiments of the present invention can be practiced.

FIG. 7 shows a block diagram showing a system for directly charging a consumer wireless account for purchases, in accordance with an embodiment of the present invention.

FIG. 8 shows a block diagram showing a system for directly charging a consumer wireless account for purchases, in accordance with another embodiment of the present invention.

FIG. 9 illustrates a sample environment for directly charging a consumer wireless account for purchases, in accordance with an embodiment of the present invention.

FIG. 10 illustrates a sample process flow for directly charging a consumer wireless account for purchases, in accordance with an embodiment of the present invention

FIGS. 11A, 11B, and 11C show an example of an application of a communication device for directly charging a consumer wireless account for purchases, in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

Before describing in detail the particular system and method system for directly charging a consumer wireless account while making a purchase through a communication device in accordance with an embodiment of the present invention, it should be observed that the present invention resides primarily in combinations of method and system components related to the communication device of the present invention.

Accordingly, the system components have been represented where appropriate by conventional symbols in the drawings, showing only those specific details that are pertinent to understanding the present invention so as not to obscure the disclosure with details that will be readily apparent to those of ordinary skill in the art having the benefit of the description herein.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

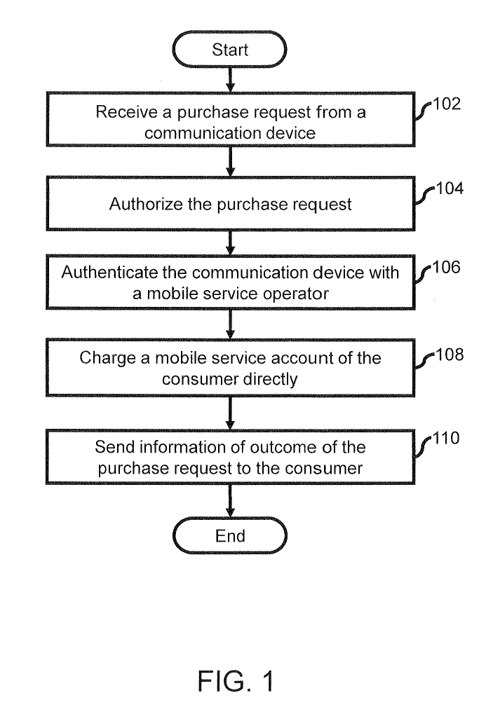

FIG. 1 shows a flow chart of a method for directly charging a consumer wireless account for purchases, in accordance with an embodiment of the present invention. A consumer/user opens an application on a communication device. The application can be one of a gaming application, content application (to download newsletters, wallpapers, ringtones etc.), e-commerce shopping application, communication, social media updating program, instant messaging or blogging program or any other type of mobile communications device application. Examples of the communication device include, but are not limited to, a mobile phone, a Personal Digital Assistant (PDA), a landline phone, a computer, a laptop, an electronic reader and a smart phone. The consumer/user selects a service/product/content to purchase. For example, in a gaming application, a game is free for a limited time, and then requires a purchase, or the consumer/user might have to purchase additional game levels or the consumer/user might have to purchase full functionality of a game. Similarly, in a content application, the user/consumer can choose to purchase and download newsletters, wallpapers etc. Similarly, in a shipping application, a user/consumer can choose to buy any product for physical delivery. In any type of application, a user may be required to pay in order to unlock functionality, or to continue accessing the application following a free-of-charge trial period of time. At step 102, a purchase request is received from the communication device by the system for directly charging a consumer wireless account for purchases. The purchase request includes information related to the purchase. In an embodiment of the present invention, the system is a 3^{rd} party billing server, which acts as an interface for billing between the communication device and the mobile operator of the consumer/user. In another embodiment of the present invention, the system under the present invention could just as easily be offered directly by a mobile operator or a handset manufacturer or purveyor who maintains consumer payment accounts corresponding to the device or subscriber.

At step 104, the system authorizes the purchase request received from the communication device. At step 106, the communication device is authenticated with the mobile service operator of the communication device. At step 108, the system charges the mobile service account of the consumer/user (mobile operator's subscriber account corresponding to the consumer/user or the communications device) directly. Once the payment is approved, the system sends information of outcome of the purchase to the communication device at step 110. Further, the system provides access of the purchased content/service/product to the communication device.

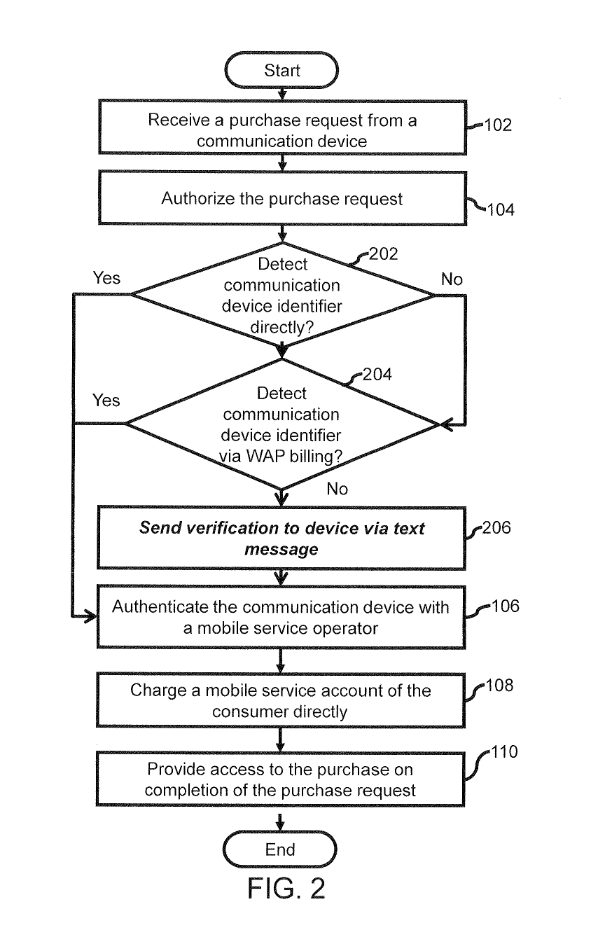

FIG. 2 shows a flow chart of a method for directly charging a consumer wireless account for purchases, in accordance with another embodiment of the present invention. At step 102, a purchase request is received from the communication device by the system for directly charging a consumer wireless account for purchases. The purchase request includes information related to the purchase. At step 1O4, the system authorizes the purchase request received from the communication device. In an embodiment of the present invention, the system authorizes the purchase request by sending a confirmation request to the communication device. The confirmation request can include one or more of terms & conditions of the purchase, amount of the purchase, and information of product being purchased. The system can send the confirmation request via one or more of displaying within the application from which the purchase request is sent, a SMS, an email and a phone call. For authenticating the communication device with the mobile service provider, at step 202, the system checks if it can detect a communication device identifier directly from the communication device. In an embodiment of the present invention, the communication device identifier is a Mobile Directory Number (MDN). In another embodiment of the present invention, the communication device identifier is a Mobile Identification Number (MIN).

In an embodiment of the present invention, at step 204, the communication device identifier is detected directly from the communication device via one of native framework API and WAP. Examples of the communication devices for which MDN is available via framework API are the devices running Android Operating System (OS). The communication device identifier can be detected directly via WAP URL.

In another embodiment of the present invention, the communication device identifier cannot be detected directly from the communication device. Examples of such communication devices include MIDP devices that support J2ME applications. At step 206, the system sends a SMS to SMS Gateway of the consumer wireless account for receiving back a SMS containing the communication device identifier. At step 106, the communication device is authenticated with the mobile service operator of the communication device.

In an embodiment of the present invention, the application communicates with the mobile operator server to authenticate the handset by identifying its presence in the public mobile operator's data network (such as an EDGE, 3G or LTE network) through, possibly through a “WAP billing” method such as is known in the art. The mobile operator then authenticates that the communication device is communicating over the mobile operator's own 3G network. Note that when interacting with mobile operators who do not offer this type of secure billing authentication, or when the device is communicating with the Internet through Wifi or some means other than the public mobile operator's own data communications infrastructure, then the billing authentication can be accomplished through an exchange of mobile handset originating “opt in” messages such as is known in the art, and is offered in the 2010 Cross-Carrier Consumer Best Practices Guidelines published by the Mobile Marketing Association, the entirety of which is incorporated by reference herein.

Alternatively, payment authentication can be accomplished through other well-known methods in the payment processing industry, such as:
a. The exchange of public and private keys between the mobile application requesting the payment and the payment server;
b. Calculating a sequential one time password (as is known in RSA SecureID devices) at the mobile application using a predetermined random seed, and applying a hash at the 3^{rd} party billing server and comparing the result to a sequential database of hashed one time password values corresponding to that communications device or mobile application instance;
c. Interrogating the user for a username and password;
d. Interrogating the user for a biometric authentication such as a fingerprint or retinal scan; or
e. Interrogating the user for a spoken password or spoken words, and analyzing the user's voice through voice recognition.

At step 108, the system charges the mobile service account of the consumer/user (mobile operator's subscriber account corresponding to the consumer/user or the communications device) directly. Once the payment is approved, the system sends information of outcome of the purchase to the communication device at step 110. Further, the system provides access of the purchased content/service/product to the communication device.

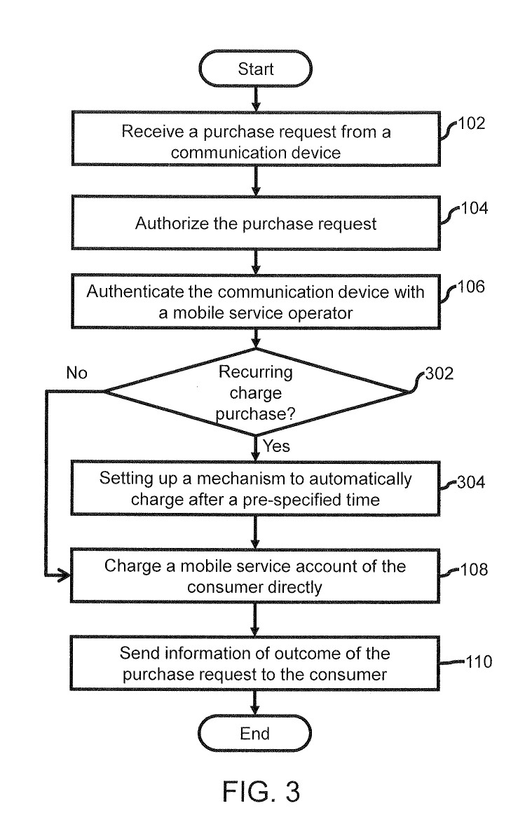

FIG. 3 shows a flow chart of a method for directly charging a consumer wireless account for purchases, in accordance with another embodiment of the present invention. At step 102, a purchase request is received from the communication device by the system for directly charging a consumer wireless account for purchases. The purchase request includes information related to the purchase. At step 104, the system authorizes the purchase request received from the communication device. At step 106, the communication device is authenticated with the mobile service operator of the communication device. At step 302, the system checks if the purchase request is for a one-time payment or a subscription based payment. In an embodiment of the present invention, the purchase request is for a subscription based payment. At step 304, the system sets up a payment mechanism to automatically charge the consumer/user after a pre-specified time. The pre-specified time can be daily, weekly, fortnightly, monthly, or yearly depending on the subscription plan established in the requesting mobile application automatically or by the user/consumer. In another embodiment of the present invention, the purchase request is a one-time payment. At step 108, the system charges the mobile operator of the consumer/user. Once the payment is approved, the system sends information of outcome of the purchase to the communication device at step 110. Further, the system provides access of the purchased content/service/product to the communication device.

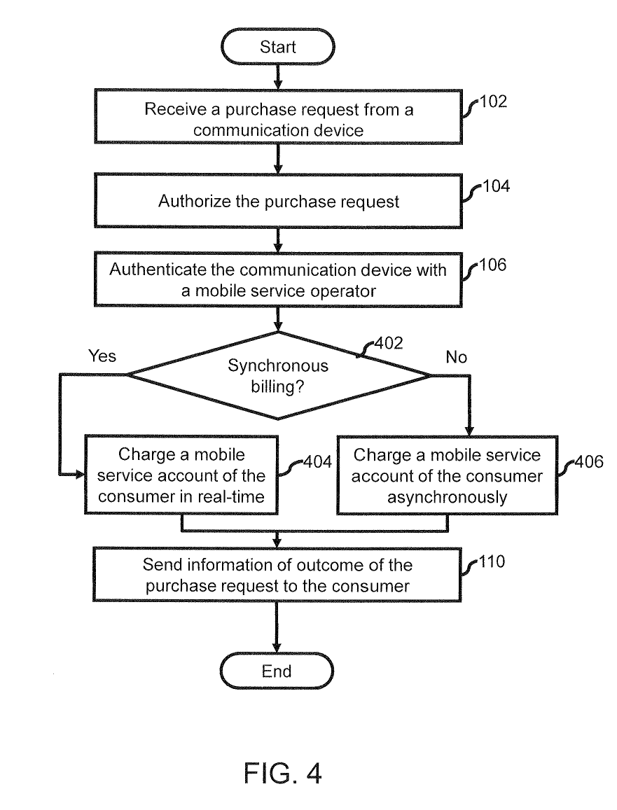

FIG. 4 shows a flow chart of a method for directly charging a consumer wireless account for purchases, in accordance with yet another embodiment of the present invention. At step 102, a purchase request is received from the communication device by the system for directly charging a consumer wireless account for purchases. The purchase request includes information related to the purchase. At step 104, the system authorizes the purchase request received from the communication device. At step 106, the communication device is authenticated with the mobile service operator of the communication device. At step 402, the system checks if the mobile service operator supports synchronous billing. In an embodiment of the present invention, the mobile service operator supports the synchronous billing. At step 404, the mobile service account of the consumer/user is charged in real-time. Once the payment is approved, the system sends information of outcome of the purchase to the communication device at step 110. In another embodiment of the present invention, the mobile service operator does not support the synchronous billing. At step 404, the mobile service account of the consumer/user is charged asynchronously. The system sends information of outcome of the purchase to the communication device at step 110. In an embodiment, access to the purchase is provided while charging the mobile operator of the consumer/user is still pending. In another embodiment, access to the purchase is not provided till charging the mobile operator of the consumer/user is completed.

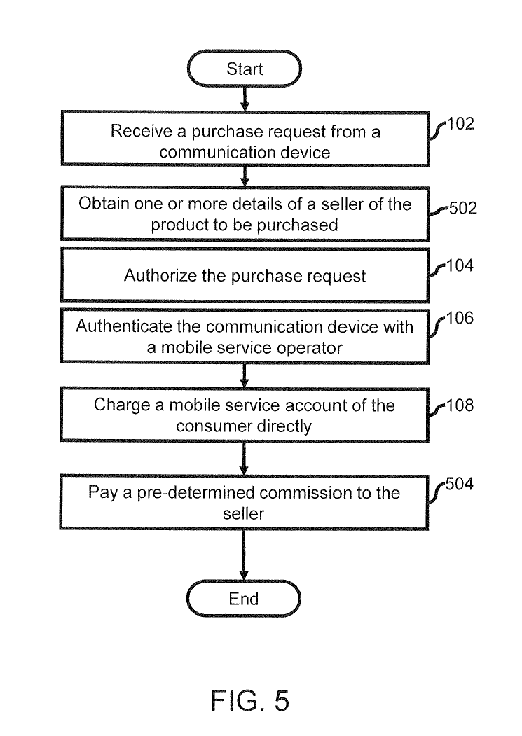

FIG. 5 shows a flow chart of a method for paying out commissions for purchases, in accordance with an embodiment of the present invention. At step 102, a purchase request is received from the communication device by the system for directly charging a consumer wireless account for purchases. The purchase request includes information related to the purchase. At step 502, the system obtains one or more details of a seller of the product to be purchased. The seller can be one of a merchant of the product, developer of the product and a marketer of the product.

At step 104, the system authorizes the purchase request received from the communication device. At step 106, the communication device is authenticated with the mobile service operator of the communication device. At step 108, the system charges the mobile service account of the consumer/user (mobile operator's subscriber account corresponding to the consumer/user or the communications device) directly. Finally, at step 504, the system pays out a pre-determined commission to the seller. In an embodiment of the present invention, the pre-determined commission is a percentage of the amount charged from the mobile service account of the consumer/user. In another embodiment of the present invention, the pre-determined commission is a fixed amount.

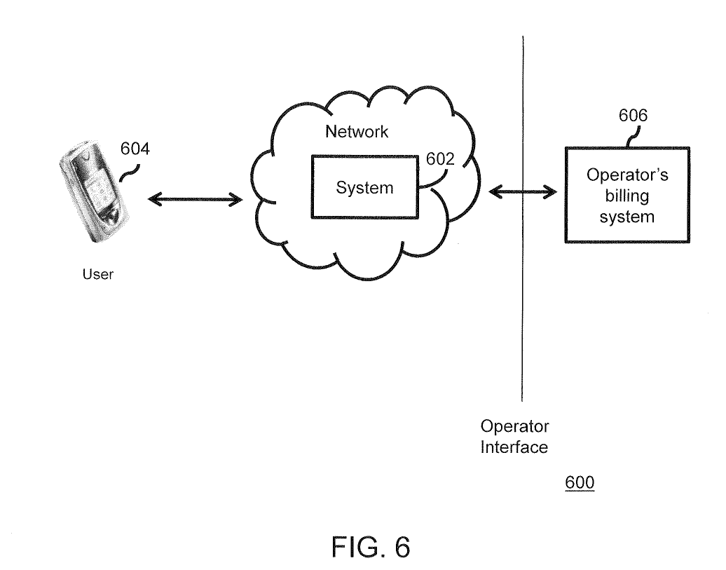

FIG. 6 illustrates an environment 600 in which various embodiments of the present invention can be practiced. The environment 600 shows a network hosting a system 602 for directly charging a consumer wireless account for purchases. Examples of the network include, but are not limited to, at least one of internet, intranet, Wifi, Bluetooth, Infrared, WiMAX, Local Area Network (LAN), GPRS, EDGE, and Virtual Private network (VPN). The environment 600 also shows a mobile device 604. Examples of the mobile device 604 include, but are not limited to, a mobile phone, a Personal Digital Assistant (PDA), a landline phone, a laptop, a computer and a pager. Further, the environment shows an operator's billing system 606. The operator's billing system 606 is the billing system of the operator of the mobile device 604. The system 602 acts as an interface between the mobile device 604 and the operator's billing system 606, where the interface directly charges the mobile number account of the mobile device 604 for purchases through the mobile device 604.

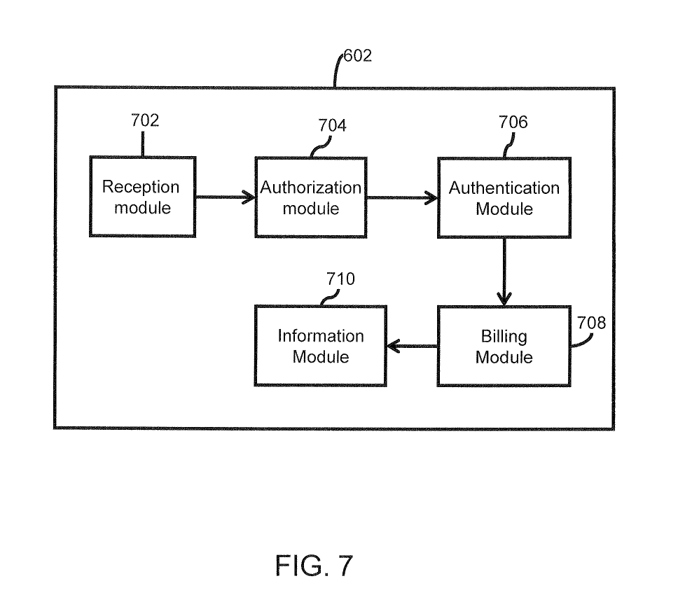

FIG. 7 shows a block diagram showing the system 602 for directly charging a consumer wireless account for purchases, in accordance with an embodiment of the present invention. The system 602 includes a reception module 702, an authorization module 704, an authentication module 706, a billing module 708 and an information module 710. The reception module 702 receives a purchase request from a communication device. The purchase request can be for purchasing content/service/product. The purchase request includes information related to the purchase. Further, the authorization module 704 authorizes the purchase request received from the communication device. The authorization includes asking for a confirmation from the communication device. On receiving the authorization, the authentication module 706 interfaces with the operator of the communication device and authenticates the communication device. Further, the billing module 708 then charges the mobile service account of the consumer directly through the mobile service operator's billing system. Finally, the information module 710 sends information of outcome of the purchase request to the communication device. Further, the information module provides access to the content/service/product requested by the communication device.

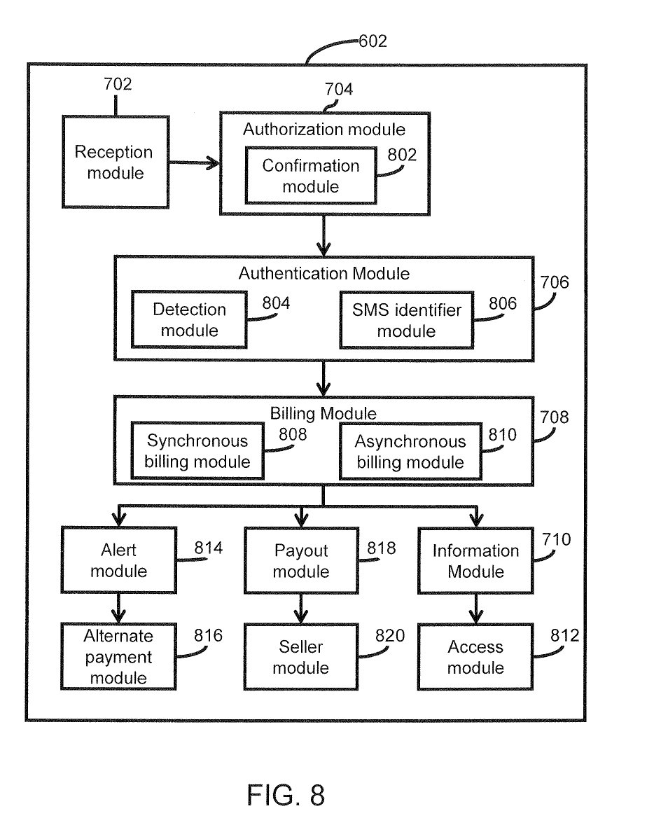

FIG. 8 shows a block diagram showing the system 602 for directly charging a consumer wireless account for purchases, in accordance with another embodiment of the present invention. The system 602 includes the reception module 702, the authorization module 704, the authentication module 706, the billing module 708, the information module 710, a confirmation module 802, a retrieval module 804, a SMS identifier module 806, a synchronous billing module 808, an asynchronous billing module 810, an access module 812, an alert module 814, an alternate payment module 816, a payout module 818 and a seller module 820.

The reception module 702 receives a purchase request from a communication device. The purchase request can be for purchasing one or more of content, service, product, newsletters, wallpapers, ringtones, games, additional game levels, and full application functionality. The purchase request includes information related to the purchase. The information can be one or more of amount of the purchase, product to be purchased and product code of the purchase. The purchase can be a one-time purchase and a recurring purchase. Further, the authorization module 704 authorizes the purchase request received from the communication device. The authorization includes a confirmation module 802 for sending a confirmation request to the communication device. The confirmation request can one or more of terms & conditions of the purchase, amount of the purchase, and information of product being purchased. Further, the confirmation request is sent via one or more of displaying within an application, a SMS, an email and a phone call.

On receiving the authorization, the authentication module 706 interfaces with the operator of the communication device and authenticates the communication device. In an embodiment of the present invention, the authentication module 706 includes the detection module. The detection module detects a communication device identifier of the communication device. The communication device identifier is one of a Mobile Directory Number (MDN) and Mobile Identification Number (MIN). Further, the detection module includes the retrieval module 804 and the SMS identifier module 806. The retrieval module 804 retrieves the communication device identifier directly from the communication device via one of a native framework API and a WAP session. The SMS identifier 806 module sends a SMS to SMS Gateway of the consumer wireless account for receiving back a SMS containing the communication device identifier.

Further, the billing module 708 then charges the mobile service account of the consumer directly through the mobile service operator's billing system. The billing module includes the synchronous billing module 808 for real time charging the mobile service account and the asynchronous billing module 810 for delayed charging the mobile service account. Finally, the information module 710 sends information of outcome of the purchase request to the communication device. Further, the access module 812 provides access to the content/service/product purchase requested by the communication device.

In an embodiment of the present invention, the system includes the alert module 814 for sending one or more alerts to the consumer when a pre-specified condition is met, where the pre-specified condition is one of insufficient prepaid balance, exceeding credit limit and approaching credit limit. Further, the alternative payment module 816 provides one or more alternative payment means to the consumer, where the one or more alternative payment means is a credit card, a bank account, a debit card and an online account.

In an embodiment of the present invention, the system includes the payout module 818 for paying out commissions. The system includes the seller module 820 for obtaining one or more details of a seller of a product to be purchased via the purchase request, where the seller is one of a merchant of the product, developer of the product and a marketer of the product. The payout module 818 pays a pre-determined commission to the seller on successful completion of the purchase request.

In an embodiment of the present invention, the system includes an account module. The account module provides one or more details of the consumer to the communication device, where the one or more details include consumer account details, status of the purchase request, purchase history and subscriptions

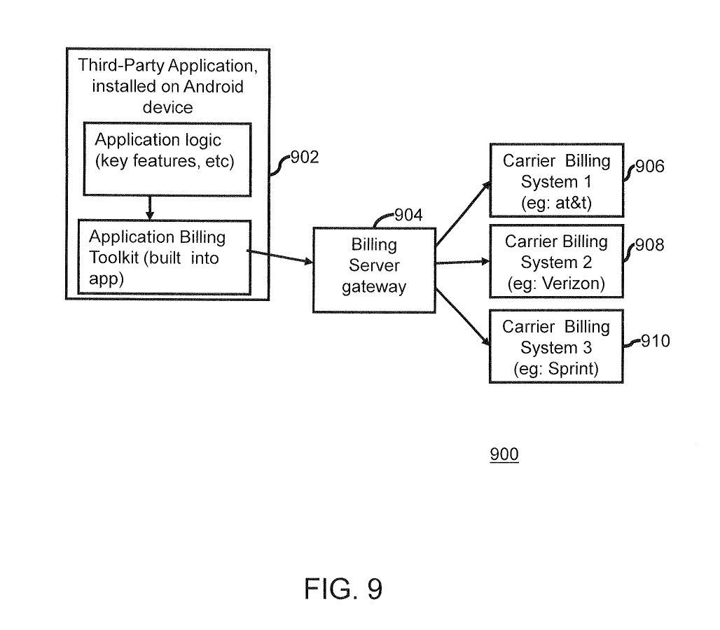

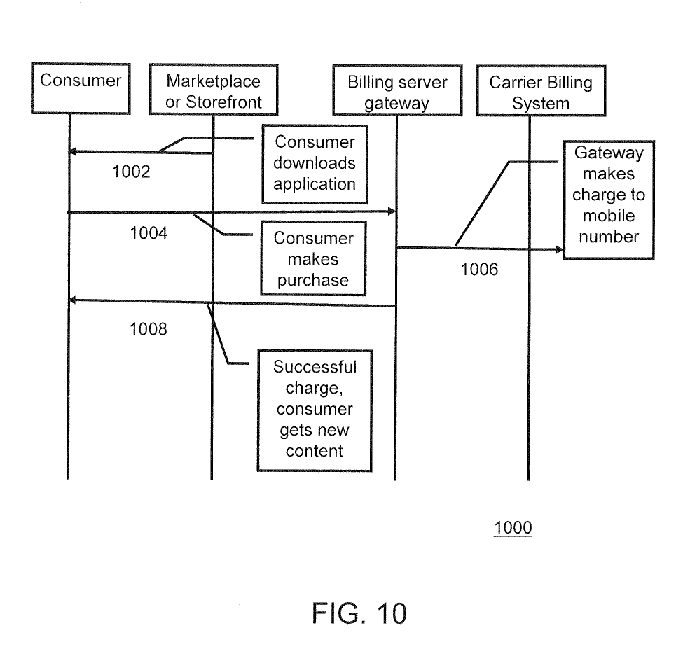

FIG. 9 illustrates a sample environment for directly charging a consumer wireless account for purchases, in accordance with an embodiment of the present invention. The figure shows a third-party application 902, a billing server gateway 904, and carrier billing systems 906, 908, and 910. The third-party application 902 includes a code module that can be embedded into an application on a mobile device. The third-party application 902 also includes code module that accesses gateway of the billing server 904 to consummate direct carrier billing. Examples of the carriers include AT&T, Verizon, Sprint and the like.

FIG. 10 illustrates a sample process flow for directly charging a consumer wireless account for purchases, in accordance with an embodiment of the present invention. At step 1002, the consumer downloads an application on a communication device from a marketplace or storefront or an application store. The consumer then accesses the application, and when the consumer wants to purchase something through the application, the consumer sends a request for the purchase through the application. At step 1004, the request for the purchase is received by the billing server gateway. The billing server then interfaces with the mobile carrier of the communication device and authenticates the communication device. Then at step 1006, the billing server charges the mobile number of the communication device through the mobile carrier. On successful charging of the mobile number, at step 1008 the billing server provides access to the consumer to the content requested by him.

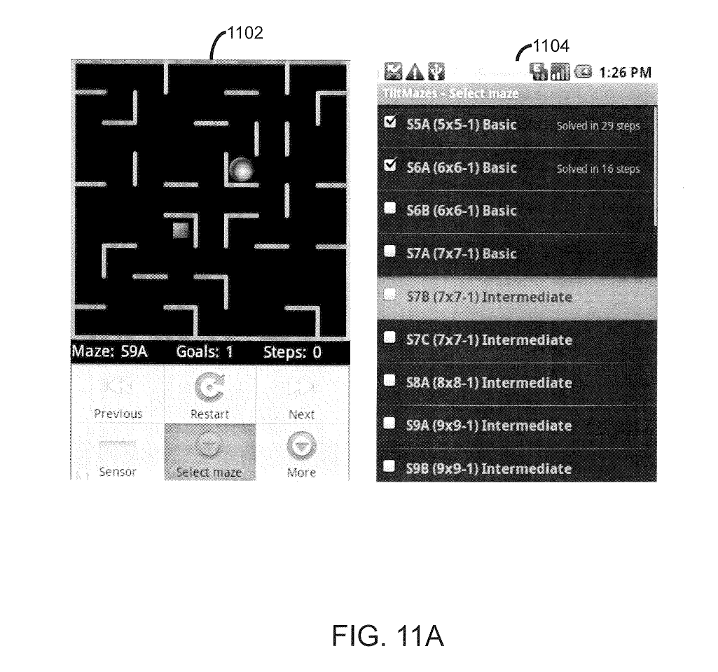

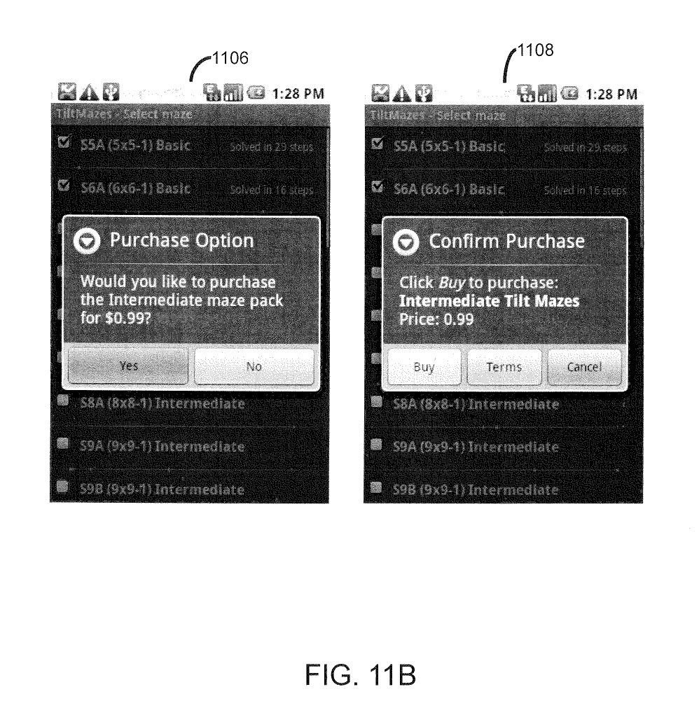

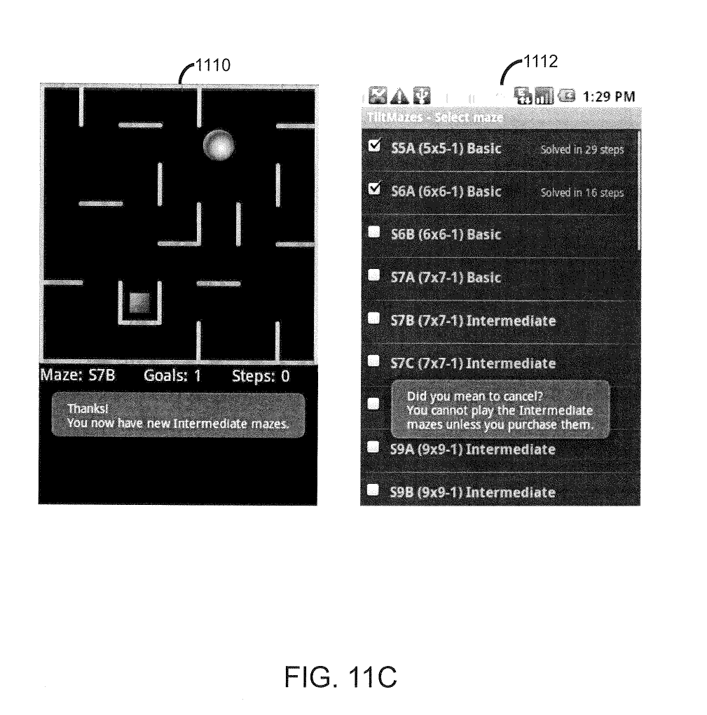

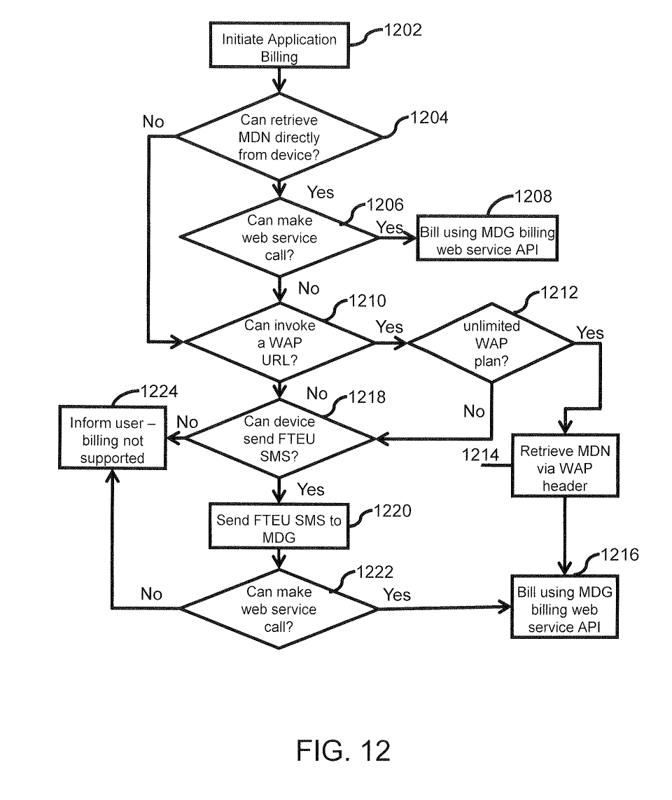

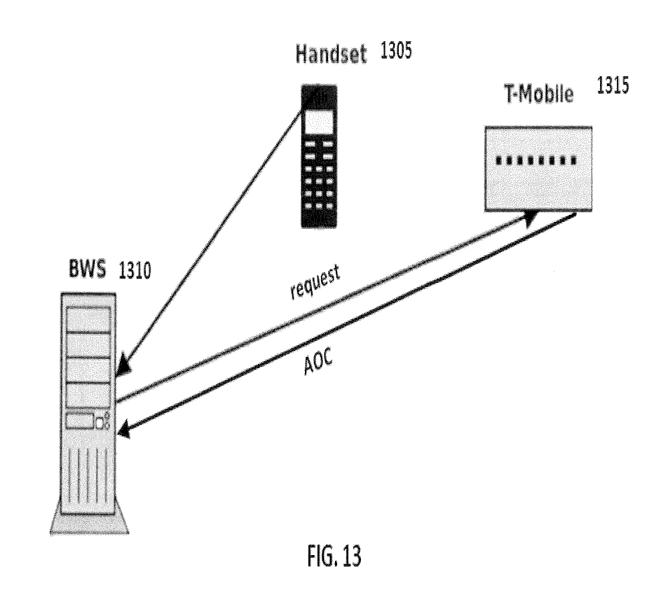

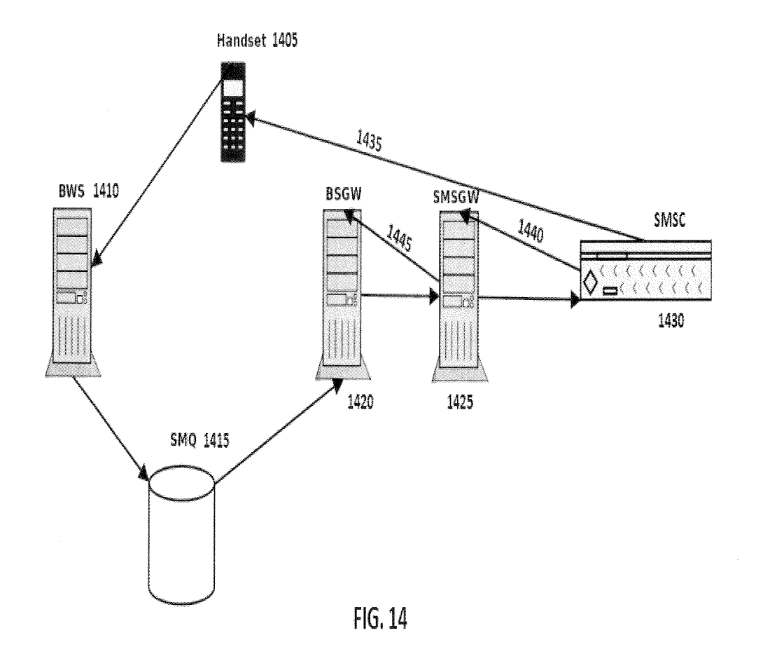

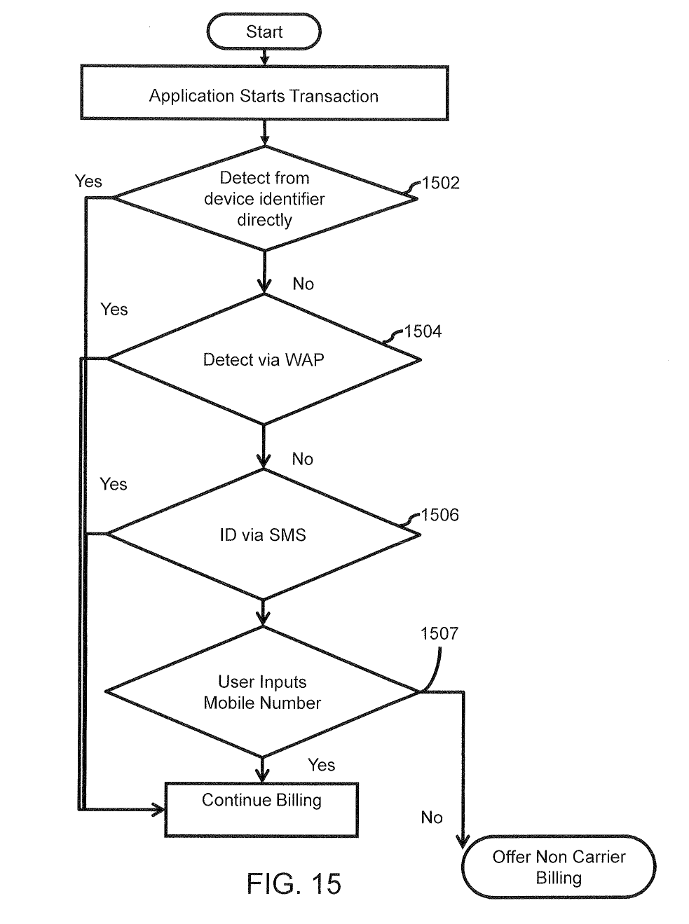

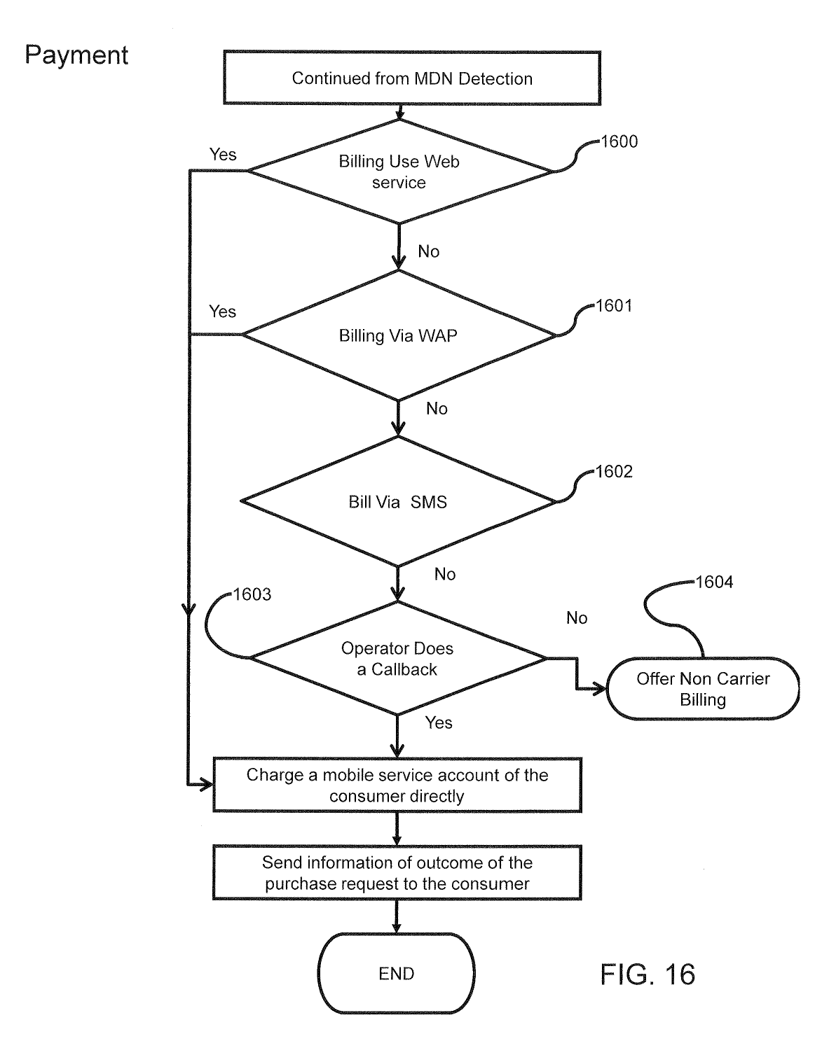

FIGS. 11A, 11B, and 11C show an example of an application of a communication device for directly charging a consumer wireless account for purchases, in accordance with an embodiment of the present invention. In FIG. 11A, screen 1102 of the communication device shows a consumer playing ‘tilt maze’ game. Screen 1104 shows that the consumer selects additional content i.e. more levels of the game, from within the application. In FIG. 11B, screen 1106 shows that the consumer is provided with an option to purchase higher level of the game. Screen 1108 shows that the consumer is asked for a confirmation, and is also presented with the terms of purchase. In FIG. 11C, screen 1108 shows that the user has purchased the additional level of the game, and is now authorized to play the higher level of the game. In another embodiment of the present invention, the screen 1110 shows that the user declined to purchase the additional level, and is thus not provided access to the high level of the game.

In an embodiment of the present invention, a billing SDK (Software Development Kit) is provided to support direct billing from mobile device applications. Although the user experience appears similar to WAP Billing, the technology is quite different. Specifically, the application is running on the consumer handset, not the Content Provider's server. And that means the connection from the handset to the billing SDK servers is not mediated through a carrier server.

Use Cases of the Billing SDK
a. Free application that charges consumer directly, without the application store.
b. Charges can be one time (item purchase) or recurring (subscription purchase).
c. Purchase can be for content: newsletters, wallpapers, etc. (Ringtones seem unlikely since smart phones have applications that can rip ringtones from full songs.)
d. Purchase can be for incremental features: additional game levels, full functionality, etc.
e. Try before you buy: application is free for limited time, then requires purchase.
f. Pay for an application through an application store or market that is running on the device. The market charges the consumer's phone bill one time for the cost of the application.
g. Web-based purchase without PIN. A traditional content site can use this feature to complete a purchase entirely within the browser experience. The browser is integrated with a secure purchasing module that handles advice of charge.

The key to each of these use cases is a module that runs on the device and makes secure web service calls to the third party billing platform. The SDK can be written in the native language of the phone: Android ->Java; Blackberry ->Java or C++; Windows Mobile ->C# and the like. The SDK is capable of supporting billing from multiple mobile service operators.

In a preferred embodiment, the SDK includes a capability of identifying a merchant or marketer who sold the mobile application. Consequently, when a user of the installed instance of the mobile application makes purchases, that merchant or marketer is identified at the 3^{rd} party billing server, and the merchant or marketer can be paid a pre-determined commission.

In an embodiment, the application includes a mechanism to charge the user and check the status of the purchase. This is especially important for subscription-based purchases.

From the server perspective, application billing under the present invention comprises a new billing channel over and above the known mobile content billing channels such as premium SMS, WAP Billing, application markets (such as Apple's App Store or the Android Market), or billing via payment card or account over the World Wide Web in a mobile web browser.

In an embodiment, the application handles the user interface and interacts with the third party billing service via web service calls, so the server does not generate any user-visible pages. Alternatively, the interaction can take place over the mobile messaging (SMS) channel, USID, or even signaling or by data communication over the voice channel or via IVR. The important difference is that the calls are made from consumer devices running a mobile application billing module, not content provider servers.

In an embodiment of the present invention, the confirmation of the purchase before charging the mobile number of a consumer is requested through external means like email, SMS, and phone call. In an embodiment of the present invention, a user is alerted when there is an insufficient balance/credit limit in his account to complete a purchase. After alerting the user, the user is provided with an option to pay through alternative means like credit card, bank account, debit card and Paypal.

In an alternative embodiment of the invention, the mobile application billing module installed on the end user device of the present invention can by default request the user to input credit card or payment account information or bill a payment card that the user has previously put on file (as is known in Google Checkout for Android Market, or iTunes accounts for the Apple App Store, or Amazon Checkout). If that payment account is not established or available, under this alternative embodiment, the mobile billing application would bill the user's mobile operator subscriber account directly.

While the present invention has been described in connection with preferred embodiments, it will be understood by those skilled in the art that variations and modifications of the preferred embodiments described above may be made without departing from the scope of the invention. Other embodiments will be apparent to those skilled in the art from a consideration of the specification or from a practice of the invention disclosed herein. It is intended that the specification and the described examples are considered exemplary only, with the true scope of the invention indicated by the following claims.

What is claimed is:

1. A method for conducting commerce with a consumer using a communication device, the method comprising:
receiving a purchase request from an application running in conjunction with the communication device, the purchase request including information related to a purchase;
authorizing the purchase request;
authenticating the communication device with a mobile service operator of the communication device and determining a mobile service account of the consumer;
directly charging an amount of the purchase to the mobile service account of the consumer; and
sending information of an outcome of the purchase request to the communication device.

2. The method as recited in claim 1, wherein the purchase request is one of a one-time purchase request and a recurring purchase request.

3. The method as recited in claim 1, wherein the purchase request is for one of a newsletter, a wallpaper, a ringtone, a content, a game, an additional game level, and full application functionality.

4. The method as recited in claim 1, wherein the information related to the purchase comprises one of an amount of the purchase, a product related to the purchase and a product code of the product related to the purchase.

5. The method as recited in claim 1, wherein authorizing the purchase request comprises sending a confirmation request to the communication device.

6. The method as recited in claim 5, wherein the confirmation request comprises one of terms and conditions of the purchase, the amount of the purchase, and information on the product relating to the purchase.

7. The method as recited in claim 5, wherein sending the confirmation request comprises one of displaying the confirmation request within an application, including the confirmation request in a SMS, including the confirmation request in an email, and making a telephone call regarding the confirmation request.

8. The method as recited in claim 1, wherein authenticating the communication device comprises detecting a communication device identifier.

9. The method as recited in claim 8, wherein the communication device identifier is one of a Mobile Directory Number (MDN) and a Mobile Identification Number (MIN).

10. The method as recited in claim 8, wherein detecting the communication device identifier comprises retrieving the communication device identifier from the communication device.

11. The method as recited in claim 10, wherein the communication device identifier is retrieved via one of a native framework API and a WAP session.

12. The method as recited in claim 8, wherein detecting the communication device identifier comprises sending a SMS to a SMS Gateway of the mobile service account to receive a responsive SMS containing the communication device identifier.

13. The method as recited in claim 1, wherein the communication is authenticated by exchanging public and private keys between the communication device and a billing server of the mobile service operator.

14. The method as recited in claim 1, wherein the communication device is authenticated by verifying the consumer, the consumer being verified via one of a username, a multiple-use password, a one-time password, biometric data and voice.

15. The method as recited in claim 1, wherein the amount of the purchase is charged to the mobile service account via one of synchronous means and asynchronous means.

16. The method as recited in claim 1, wherein sending information of the outcome of the purchase request further comprises:
providing access to the purchase on completion of the purchase request.

17. The method as recited in claim 1 further comprising:
providing a detail of the consumer to the communication device, the details comprising one of consumer account details, a status of the purchase request, purchase history and subscriptions.

18. The method as recited in claim 1 further comprising:
sending one or more alerts to the consumer when a pre-specified condition is met, the pre-specified condition being one of insufficient prepaid balance, exceeding credit limit and approaching credit limit.

19. The method as recited in claim 18, wherein sending the one or more alerts further comprises:
providing one or more alternative payment methods to the consumer, the one or more alternative payment methods comprising one of a credit card, a bank account, a debit card and an online account.

20. The method as recited in claim 1 further comprising:
obtaining one or more details of a seller of the product related to the purchase via the purchase request, the seller being one of a merchant of the product, a developer of the product and a marketer of the product.

21. The method as recited in claim 20 further comprising:
paying a pre-determined commission to the seller on successful completion of the purchase request.

22. A system for conducting commerce with a consumer using a communication device, the system comprising:
a reception module, the reception module receiving a purchase request from an application running in conjunction with the communication device, the purchase request including information related to a purchase;
an authorization module, the authorization module authorizing the purchase request;
an authentication module, the authentication module authenticating the communication device with a mobile service operator of the communication device and determining a mobile service account of the consumer;
a billing module, the billing module directly charging an amount of the purchase to the mobile service account of the consumer; and
an information module, the information module sending information of an outcome of the purchase request to the communication device.

23. The system as recited in claim 22, wherein the purchase request is one of a one-time purchase request and a recurring purchase request.

24. The system as recited in claim 22, wherein the purchase request is for one of a newsletter, a wallpaper, a ringtone, a content, a game, an additional game level, and full application functionality.

25. The system as recited in claim 22, wherein the information related to the purchase comprises one of an amount of the purchase, a product related to the purchase and a product code of the product related to the purchase.

26. The system as recited in claim 22, wherein the authorization module comprises a confirmation module, the confirmation module sending a confirmation request to the communication device.

27. The system as recited in claim 26, wherein the confirmation request comprises one of terms and conditions of the purchase, the amount of the purchase, and information on the product relating to the purchase.

28. The system as recited in claim 26, wherein sending the confirmation request comprises one of displaying the confirmation request within an application, including the confirmation request in a SMS, including the confirmation request in an email, and making a telephone call regarding the confirmation request.

29. The system as recited in claim 22, wherein the authentication module comprises a detection module, the detection module detecting a communication device identifier.

30. The system as recited in claim 29, wherein the communication device identifier is one of a Mobile Directory Number (MDN) and a Mobile Identification Number (MIN).

31. The system as recited in claim 29, wherein the detection module comprises a retrieval module, the retrieval module retrieving the communication device identifier from the communication device.

32. The system as recited in claim 31, wherein the communication device identifier is retrieved via one of a native framework API and WAP session.

33. The system as recited in claim 29, wherein the detection module comprises a SMS identifier module, the SMS identifier module sending a SMS to SMS Gateway of the consumer wireless account for receiving back a SMS containing the communication device identifier.

34. The system as recited in claim 22, wherein the authentication module comprises a key authentication module, the key authentication module authenticating by exchanging public and private keys between the communication device and billing server of the mobile service operator.

35. The system as recited in claim 22, wherein the authentication module comprises a verification module, the verification module authenticating by verifying the consumer, the consumer being verified via one or more of a username, a multiple-use password, a one-time password, biometric data and voice.

36. The system as recited in claim 22, wherein the billing module comprises a synchronous billing module and an asynchronous billing module.

37. The system as recited in claim 22, wherein the information module further comprises:
an access module, the access module providing access to the purchase on completion of the purchase request.

38. The system as recited in claim 22 further comprising:
an account module, the account module providing details of the consumer to the communication device, the details comprising one of consumer account details, a status of the purchase request, purchase history and subscriptions.

39. The system as recited in claim 22 further comprising:
an alert module, the alert module sending one or more alerts to the consumer when a pre-specified condition is met, the pre-specified condition being one of insufficient prepaid balance, exceeding credit limit and approaching credit limit.

40. The system as recited in claim 39, wherein the alert module comprises an alternative payment module, and wherein the alternative payment module providing one or more alternative payment methods to the consumer, the one or more alternative payment methods comprising one of a credit card, a bank account, a debit card and an online account.

41. The system as recited in claim 22 further comprising a seller module, the seller module obtaining one or more details of a seller of the product related to the purchase via the purchase request, the seller being one of a merchant of the product, a developer of the product and a marketer of the product.

42. The system as recited in claim 41 wherein the seller module further comprises:
a payout module, the payout module paying a pre-determined commission to the seller on successful completion of the purchase request.

43. A computer program product for use with a computer, the computer program product comprising a computer usable medium having a computer readable program code stored thereon for conducting commerce with a consumer using a communication device, the computer program product performing the steps of:
receiving a purchase request from an application running in conjunction with the communication device, the purchase request including information related to a purchase;
authorizing the purchase request;
authenticating the communication device with a mobile service operator of the communication device and determining a mobile service account of the consumer;
directly charging an amount of the purchase to the mobile service account of the consumer; and
sending information of an outcome of the purchase request to the communication device.

44. The computer program product as recited in claim 43, wherein authorizing the purchase request comprises sending a confirmation request to the communication device.

45. The computer program product as recited in claim 43, wherein authenticating the communication device comprises detecting a communication device identifier.

46. The computer program product as recited in claim 45, wherein detecting the communication device identifier comprises retrieving the communication device identifier from the communication device.

47. The computer program product as recited in claim 46, wherein the communication device identifier is retrieved via one of a native framework API and a WAP session.

48. The computer program product as recited in claim 45, wherein detecting the communication device identifier comprises sending a SMS to a SMS Gateway of the mobile service account to receive a responsive SMS containing the communication device identifier.

49. The computer program product as recited in claim 43, wherein the communication is authenticated by exchanging public and private keys between the communication device and a billing server of the mobile service operator.

50. The computer program product as recited in claim 43, wherein the communication device is authenticated by verifying the consumer, the consumer being verified via one of a username, a multiple-use password, a one-time password, biometric data and voice.

51. The computer program product as recited in claim 43, wherein the amount of the purchase is charged to the mobile service account via one of synchronous means and asynchronous means.

52. The computer program product as recited in claim 43, wherein sending information of the outcome of the purchase request further comprises:
providing access to the purchase on completion of the purchase request.

53. The computer program product as recited in claim 43 further performing the steps of:
providing a detail of the consumer to the communication device, the details comprising one of consumer account details, a status of the purchase request, purchase history and subscriptions.

54. The computer program product as recited in claim 43 further performing the steps of:
sending one or more alerts to the consumer when a pre-specified condition is met, the pre-specified condition being one of insufficient prepaid balance, exceeding credit limit and approaching credit limit.

55. The computer program product as recited in claim 54, wherein sending the one or more alerts further comprises:
providing one or more alternative payment computer program products to the consumer, the one or more alternative payment computer program products comprising one of a credit card, a bank account, a debit card and an online account.

56. The computer program product as recited in claim 43 further performing the steps of:
obtaining one or more details of a seller of the product related to the purchase via the purchase request, the seller being one of a merchant of the product, a developer of the product and a marketer of the product.

57. The computer program product as recited in claim 56 further performing the steps of:
paying a pre-determined commission to the seller on successful completion of the purchase request.
